(19) United States
(12) Patent Application Publication
(10) Pub. No.: US 2024/0064482 A1
(43) Pub. Date: Feb. 22, 2024

(54) SELF-CALIBRATION FOR AUDIO DEVICES

(71) Applicant: Apple Inc., Cupertino, CA (US)

(72) Inventors: Caleb RAU, San Francisco, CA (US); Mark P. NOON, San Jose, CA (US); Victoria CHIU, San Jose, CA (US); Aditya SRINIVAS, Santa Clara, CA (US); Darrin K. REED, Campbell, CA (US); Baptiste P. PAQUIER, Saratoga, CA (US); Lalin S. THEVERAPPERUMA, Cupertino, CA (US)

(21) Appl. No.: 18/225,664

(22) Filed: Jul. 24, 2023

Related U.S. Application Data
(60) Provisional application No. 63/399,618, filed on Aug. 19, 2022.

(51) Int. Cl. H04R 29/00; H04R 25/00; H04R 1/10

(52) U.S. Cl. CPC H04R 29/001; H04R 25/70; H04R 1/1091; H04R 2460/17; H04R 2460/01; H04R 1/1025

(57) ABSTRACT

Aspects of the subject technology provide for calibration of audio devices in a case. In some implementations, the calibration techniques may include detecting that an audio device is docked in a case and a lid of the case is in a closed position, where the audio device is positioned in a cavity of the case. In addition, the calibration techniques may include emitting a test audio signal from a speaker of the audio device into the case. The device may include receiving, in response to the test audio signal, a received signal at a sensor inside the case. Moreover, the device may include obtaining a correction for the audio device based on the received signal.

### CROSS REFERENCE TO RELATED APPLICATION

This application claims the benefit of U.S. Provisional Application No. 63/399,618, entitled “SELF-CALIBRATION FOR AUDIO DEVICES,” filed Aug. 19, 2022, the entirety of which is incorporated herein by reference.

### TECHNICAL FIELD

The present description relates generally to audio input and output devices, including, for example, earbuds and audio headsets.

### BACKGROUND

Modern personal audio devices may include both a speaker and a microphone. In some cases, such as earbuds or an audio headset, the audio device may include multiple speakers and/or microphones for each ear, and an audio device may provide advanced features such as noise cancellation. Performance of an audio device may be improved with individualized calibration of each instance of an audio device, for example where small manufacturing variations in physical dimensions of an audio transducer may affect a transfer function of a micro-speaker. Such calibration of individual audio devices may be performed at the time of manufacturing of the audio device.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example audio device case in a closed configuration.

FIG. 2 illustrates an example audio system including two audio device earpieces and an audio device case in an open configuration.

FIG. 3 illustrates an example method for calibration of an audio device.

FIG. 4 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Techniques for improved calibration of audio devices include emitting and sensing test audio signals while one or more audio devices are docked in an audio device case. Calibration performed within a cavity of a storage case after the time of manufacturing allows for recalibration after consumer use. Recalibration after consumer use has many uses, including, for example, identification of audio performance changes and/or correction of faults that occur during normal consumer use of an audio device. For example, dropping an earbud may change the physical dimension of a speaker or microphone port, which may lead to small changes in a frequency response of the earbud. Recalibration of an audio device after consumer device use may also allow for identification of changes in a frequency response of an element of the audio device and a derived error correction may be applied to subsequent uses of the effected audio device. Other changes caused by consumer use of an audio device that may identified and/or corrected include collection of earwax or other substances (e.g., dirt) on the audio device, accumulation of moisture inside the audio device, etc.

In other aspects, regular (e.g., annual) recalibration may be required by audiometry applications, such as where Food and Drug Administration (FDA) approval of a human hearing test system may require regular testing to ensure an audio device continues to meet particular requirements, e.g. ANSI S3.6 requirements for an audiometer (an audiometry test device). In another aspect, recalibration may be required for hearing compensation applications in order to meet hearing aid compliance standards, such as ANSI CTA 2051/ANSI S3.22.

An audio system may include one or more audio devices and a case for holding the one or more audio devices. For example, an audio system may include a case for storing and/or charging a pair of earbuds when not in use by a user. The system may include one or more audio emitters and one or more sensors. For example, each of a pair of earbuds may include a speaker, an inner microphone (mic), and an outer mic. The case may include a cavity for holding each of the pair of earbuds, and the earbud-holding cavities may be acoustically coupled to each other, for example via a cavity in a lid of the case. An audio system may further include a processor for performing a calibration process of the audio system, including calibration of any speaker or sensor in the audio system.

A calibration process for an audio system may include, after determining that one or more audio device(s) are docked in their case with a lid closed, emitting, by a speaker in the audio system, a test audio signal into the case. The test audio signal may be sensed by one or more sensors in the case, and the received signal(s) may be analyzed to identify a fault and/or a correction for future use of the audio device(s). For example, the transfer function measured between the emitting and sensing of the test audio signal within the controlled environment of a cavity within the case may enable identification of changes to audio performance of various audio elements of the audio device(s). The received signals may be compared to each other and/or compared to corresponding reference received signals to identify the changes or faults. Alternately, or in addition, the comparison of received test audio signals may be used to identify a correction for the audio system. In some aspects, the correction may be applied to future uses of the audio device(s), for example when the audio device(s) are no longer docked in the case.

FIG. 1 illustrates an example audio device case 100 in a closed configuration. The audio device case 100 may include a base 102 and a movable lid 104. The case 100 may provide storage for one or more audio devices, and the combination of the case and its corresponding audio device(s) may comprise an audio system. In an aspect, the audio device case 100 may provide storage for its corresponding audio device(s) when they are not in use by an audio device user, and may further enable maintenance features of audio devices, such as electrical charging of batteries in audio devices, and/or calibration of one or more of the audio devices, as explained further herein. In another aspect, case 100 may enable simultaneous charging and calibration of audio devices while stored in the case.

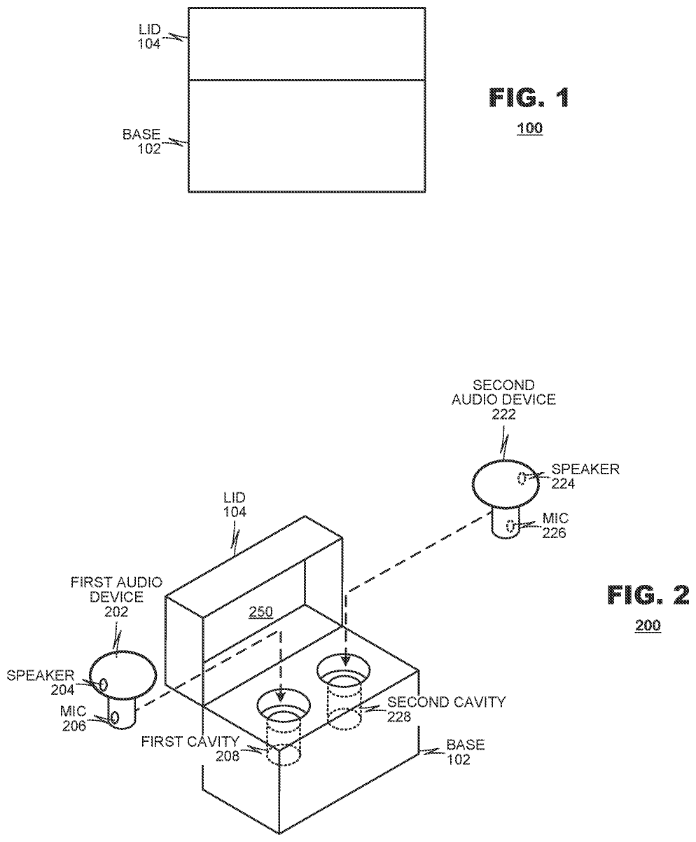

FIG. 2 illustrates an example audio system 200 including two audio device earpieces and an audio device case in an open configuration. In FIG. 2, the audio device case 100 of FIG. 1 is depicted with lid 104 in an open configuration, exposing a first cavity in base 102 for holding a corresponding first audio device 202, and a second cavity 228 in base 102 for holding a second audio device 222. First audio device 202 includes speaker 204 and mic 206, while second audio device 222 include speaker 224 and mic 226. Lid 104 may include a cavity 250 for enclosing upper portions of the audio devices 202, 222 when the lid is in a closed configuration. In an aspect, the cavity 250 in lid 104 may acoustically couple the first cavity 208 and second cavity 228.

In other aspects not depicted in FIG. 2, the first and second cavities 208, 228 may spatially overlap and be merged into a single cavity for holding both first and second audio devices 202, 222. In an aspect, case 100 may include speaker(s) and/or mic(s) for use, for example, in calibration of the audio devices. In an aspect, audio devices are not limited to earbuds; an audio device stored in a case of an audio system may include other types of audio input and output devices, such an over-the-ear audio headset, personal microphones, and the like.

In another aspect not depicted in FIG. 2, an audio device, such as the first or second audio device 202, 222, may include different numbers of speakers and sensors. For example, an earbud audio device may have an inner sensor (which may be positioned inside an ear canal when worn by a user), an outer sensor (which may be positioned outside the ear canal when worn by the user), and a primary speaker for transducing an audio signal from an audio source into sounds audible to a user. The outer sensor may be a mic for sensing, for example, the user's speech, while the inner sensor may be an “error mic” used, for example, for acoustic noise cancelation (ANC). In some aspects, an audio device sensor may be an accelerometer. In other aspects, an audio device may have only speakers or sensors and not both (for example a first device has only speakers, and a second device has only sensors).

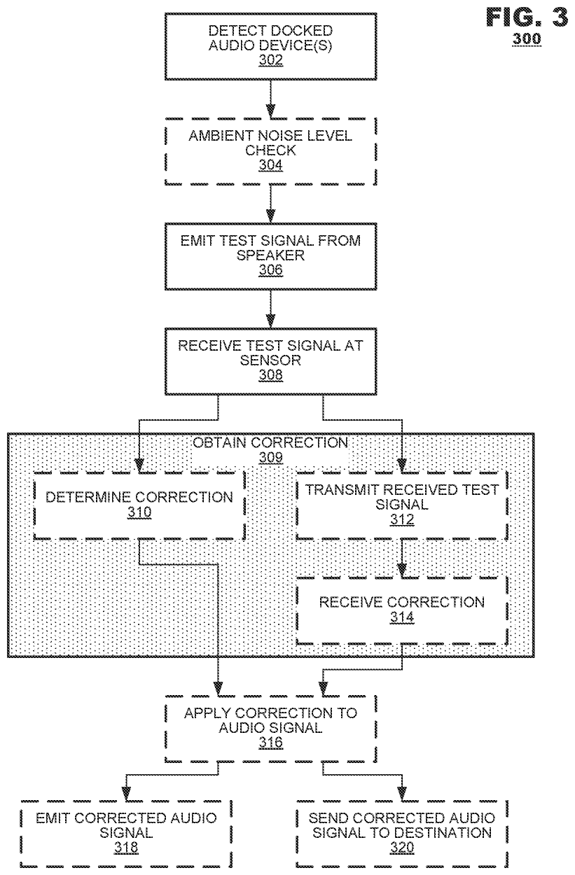

FIG. 3 illustrates an example method 300 for calibration of an audio device of an audio system. Method 300 includes detecting that one or more audio device(s) are docked in an audio device case (box 302). A test audio signal may be emitted from a speaker inside the case (box 306), and then in response the test audio signal may be received by a sensor inside the case (box 308). A correction may be obtained based on the received test audio signal (box 309).

In an example of method 300, docking of an audio device may be detected by determining a first audio device is positioned in a cavity inside the case and that a lid of the case is in a closed position. The emitting speaker inside the case may be in a docked audio device, or may be part of the case itself. The test audio signal emitted by the speaker may be sourced from an audio source device, for example a cell phone paired via Bluetooth to an audio device or the case. The sensor receiving the emitted test audio signal may be any sensor in the case. For example, a test audio signal emitted by a speaker of a first audio device in the case may be received by a sensor also of the same first audio device. Alternately, the test audio signal emitted by a speaker in a first audio device may be received by a sensor of a different second audio device. Additionally, an emitted test audio signal may be received by more than one sensor inside the case, such as by two sensors on the emitting device, or one sensor on two difference audio devices.

Optional operations in method 300 include checking an ambient noise level around the case (box 304), for example by measure a noise level inside the case and comparing it to a threshold. A received test audio signal may be used to determine a correction for future use. In a first aspect, obtaining a correction (box 309) may include determining a correction (box 310) based on the received test audio signal, for example locally at a processor that is controlling method 300. In a second aspect, obtaining a correction (box 309) may include transmitting the received test audio signal to a remote device (box 312), which may determine the correction and return it, and the correction may then be received (box 314). In the second aspect, the remote device may be, for example, a phone paired with the audio device, or the remote device may be a cloud computing server, and in some cases the source of the audio test audio signal may be the same as the remote device performing analysis of the received test audio signal.

The correction may then be applied to an audio signal (box 316) input to or output from the audio device. In an output example, an audio signal may be received from a paired audio source device, corrected (box 316), and then the corrected audio signal may be emitted (box 318) via a speaker of an audio device, for example after the audio device has been removed from the case and is being worn by a user. In an input example, an audio signal maybe recoded by a microphone sensor of the audio device (such as after being removed from the case), the recorded audio signal may be corrected (box 316), and then the corrected audio signal may be transmitted to a paired audio destination device (box 320).

In an aspect, a received test audio signal may be used to determine a fault in an audio component of an audio device. A fault may include, example, any change to the audio performance of any speaker or sensor in the audio device since a prior measurement of the faulty speaker or sensor. For example, the received test audio signal may be compared to test audio signals from a prior calibration; or the received test audio signal may be used to determine a transfer function of the audio system and the transfer function may be compared to a prior measurement of the transfer function (such as might be determined during a prior calibration). In one example, a reference transfer function for corresponding pairs of speakers and sensors inside a case may be determined during commissioning of the audio system as part of the manufacturing process, and then those reference transfer functions may be compared to corresponding new transfer functions determined during subsequent re-calibration processes.

In other aspects, analysis of received audio signal(s) may determine alternate types of faults, such as determining a partial or complete blocking of an audio port or vent for a speaker or sensor (such as by dirt, water, or earwax), or determining damage to circuitry of the audio device (such as water damage).

In an aspect, a correction (such as may be determined in box 310 or received in box 314) may be based on analysis of the received test audio signal(s), and may be based on a detected fault. In a first example, analysis of a received test audio signal may determine that a fault includes an altered frequency response of a speaker or mic in the audio device (for example, a speaker may have reduced response to certain frequencies due to deformation of a chamber in the acoustic transducer after dropping the audio device), and correction may include application of a fault mitigating filter that substantially compensates for the fault by amplifying the frequency range of reduced frequency response. For example, the fault mitigating filter may be applied to an audio signal prior to emitting it from a faulty speaker (as shown in boxes 316, 317); or alternately, the fault mitigating filter may be applied to a signal received at a faulty sensor after the signal is sensed (not depicted in method 300).

In an aspect, analysis of the received test audio signal may additionally be based on a determination of a configuration of an audio device or a configuration of a case. For example, some earbuds allow for attachment of sizing element to alter a size or shape of an earbud to a particular user's ear. When such attachments may alter the received test audio signal (and alter a transfer function derived from the received test audio signal). In some aspects, a calibration process may determine what configuration an audio device under test is in (such as which sizing element is attached), and any identified fault or correction may be further based on the determined configuration. Similarly, a case may be in an open configuration, a closed configuration, or something other configuration, and a fault or correction determined by calibration may additionally be based on such a case configuration.

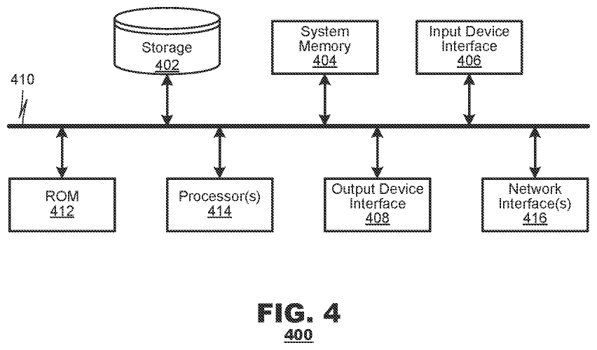

FIG. 4 illustrates an example computing device 400 with which aspects of the subject technology may be implemented in accordance with one or more implementations. The computing device 400 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 400 may include various types of computer readable media and interfaces for various other types of computer readable media. The computing device 400 includes a permanent storage device 402, a system memory 404 (and/or buffer), an input device interface 406, an output device interface 408, a bus 410, a ROM 412, one or more processing unit(s) 414, one or more network interface(s) 416, and/or subsets and variations thereof.

The bus 410 collectively represents all system, peripheral, and chipset buses that communicatively connect the numerous internal devices of the computing device 400. In one or more implementations, the bus 410 communicatively connects the one or more processing unit(s) 414 with the ROM 412, the system memory 404, and the permanent storage device 402. From these various memory units, the one or more processing unit(s) 414 retrieves instructions to execute and data to process in order to execute the processes of the subject disclosure. The one or more processing unit(s) 414 can be a single processor or a multi-core processor in different implementations.

The ROM 412 stores static data and instructions that are needed by the one or more processing unit(s) 414 and other modules of the computing device 400. The permanent storage device 402, on the other hand, may be a read-and-write memory device. The permanent storage device 402 may be a non-volatile memory unit that stores instructions and data even when the computing device 400 is off. In one or more implementations, a mass-storage device (such as a magnetic or optical disk and its corresponding disk drive) may be used as the permanent storage device 402.

In one or more implementations, a removable storage device (such as a floppy disk, flash drive, and its corresponding disk drive) may be used as the permanent storage device 402. Like the permanent storage device 402, the system memory 404 may be a read-and-write memory device. However, unlike the permanent storage device 402, the system memory 404 may be a volatile read-and-write memory, such as random-access memory. The system memory 404 may store any of the instructions and data that one or more processing unit(s) 414 may need at runtime. In one or more implementations, the processes of the subject disclosure are stored in the system memory 404, the permanent storage device 402, and/or the ROM 412. From these various memory units, the one or more processing unit(s) 414 retrieves instructions to execute and data to process in order to execute the processes of one or more implementations.

The bus 410 also connects to the input and output device interfaces 406 and 408. The input device interface 406 enables a user to communicate information and select commands to the computing device 400. Input devices that may be used with the input device interface 406 may include, for example, alphanumeric keyboards and pointing devices (also called “cursor control devices”). The output device interface 408 may enable, for example, the display of images generated by computing device 400. Output devices that may be used with the output device interface 408 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 4, the bus 410 also couples the computing device 400 to one or more networks and/or to one or more network nodes through the one or more network interface(s) 416. In this manner, the computing device 400 can be a part of a network of computers (such as a LAN, a wide area network (“WAN”), or an Intranet, or a network of networks, such as the Internet. Any or all components of the computing device 400 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

Some summary aspects of this disclosure are provided below.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method implementing the subject technology may include detecting that a first audio device is docked in an audio device case and a lid of the audio device case is in a closed position, where the first audio device is positioned in a first cavity of the audio device case. The method may also include emitting a test audio signal from a first speaker of a first audio device into the audio device case. The method may furthermore include receiving, in response to the test audio signal, a first received signal at a first sensor inside the audio device case. The method may in addition include obtaining a first correction for the first audio device based on the first received signal. Other embodiments of this aspect include corresponding computer systems, apparatus, and computer programs recorded on one or more computer storage devices, each configured to perform the actions of the methods.

Implementations may include one or more of the following features. A method may include: transmitting the first received signal to a computing system that is paired with the audio system; and receiving, from the computing system, a first correction derived in part from the first received signal. The method where the audio device case includes a processor, and the method is may include: transmitting the first received signal to the audio device case; and receiving, from the audio device case, a first correction derived by the processor in part from the first received signal. The method may include: receiving, by the first audio device, an output signal; applying the first correction to the output signal to produce a corrected signal; and while the first audio device is not docked in the audio device case, emitting the corrected signal by the first speaker of the first audio device. The method where the output signal is emitted into an acoustic cavity of a human ear, the output signal is part of an audiometry test of the human ear, and the method is may include: in response to the emitting the output signal, collecting results of the audiometry test; and transmitting data representing an audiogram based on the results from the audiometry test. The method where the output signal is emitted into an acoustic cavity of a human ear, the output signal is a noise canceling signal, and may include: sensing noise outside the acoustic cavity of the human ear; and generating the noise canceling signal based on the sensed noise and the first correction. The method where the output signal is emitted into an acoustic cavity of a human ear, and the method is may include: applying a hearing compensation correction for the human ear to the output signal based on the first correction. The method where the output signal is emitted into an acoustic cavity of a human ear, and may include: analyzing the first received signals; identifying a type of fault in first the audio system based on the analyzing; and selecting the first correction based on the identified type of fault. The method may include: comparing the first received signal to a corresponding reference signal; and where the first correction is determined based on the comparing to the corresponding reference signals. The method where the corresponding reference signals were previously captured from sensors in an acoustic cavity of a test environment different from the acoustic cavity of the audio device case. The method where the corresponding reference signals were previously captured from sensors in the acoustic cavity of the audio device case. The method may include: estimating a first transfer function between the first speaker of the first audio device and the first sensor of the audio system based on the first received signal; and comparing the first transfer function to corresponding reference transfer function; where the first correction is determined based on the comparing to reference transfer functions. The method where the first sensor of the audio system is an accelerometer. The method where the first sensor of the audio system is an audio sensor of the first audio device, and may include: receiving, in response to the test audio signal, a second received signal at a second sensor of the first audio device; receiving, in response to the test audio signal, a third received signal at a first sensor of a second audio device docked in the audio device case; and receiving, in response to the test audio signal, a fourth received signal at a second sensor of the second audio device; where the first correction is determined based on the first, second, third, and fourth received signals. The method may include: emitting a second test audio signal into the audio device case from a first speaker of a second audio device docked in the audio device case; receiving, in response to the second test audio signal, a second received signal at the first sensor of the first audio device; determining a second correction for the second audio device based on the second received signal. The method may include: prior to emitting the test audio signal, measuring an ambient noise; and confirming a magnitude of the ambient noise is below a threshold. The method may include: evaluate a plurality of acoustic components of the audio system based on the first received signals; and identifying an acoustic component of the plurality of acoustic components as having a failure state; where the first correction includes a correction for the failure state of the identified acoustic component. The method where the first sensor is part of the first audio device, and may include: while the first audio device is not docked in the audio device case, receiving a first input signal at the first sensor; applying the first correction to the first input signal to create a corrected input signal; and transmitting the corrected input signal to a paired device. Implementations of the described techniques may include hardware, a method or process, or a computer tangible medium.

In one general aspect, audio system may include an audio device case including a base, a lid, a first cavity, and a second cavity. Audio system may also include a first audio device capable of docking in the first cavity of the audio device case and including a first speaker and a first sensor. System may furthermore include a second audio device capable of docking in the second cavity of the audio device case and including a first speaker and a first sensor. System may in addition include a processor configured to execute instructions that cause: detecting that the first audio device is docked in the first cavity, the second device is docked in the second cavity; and the lid is in a closed position; emitting a test audio signal from the first speaker into the audio device case; receiving, in response to the test audio signal, a first received signal at a sensor inside the audio device case; obtaining a first correction for the first audio device based on the first received signal. Other embodiments of this aspect include corresponding computer systems, apparatus, and computer programs recorded on one or more computer storage devices, each configured to perform the actions of the methods.

What is claimed is:

1. A method for calibrating an audio system, comprising:
detecting that a first audio device is docked in an audio device case and a lid of the audio device case is in a closed position, wherein the first audio device is positioned in a first cavity of the audio device case;
emitting a test audio signal from a first speaker of a first audio device into the audio device case;
receiving, in response to the test audio signal, a first received signal at a first sensor inside the audio device case; and
obtaining a first correction for the first audio device based on the first received signal.

2. The method of claim 1, further comprising:
transmitting the first received signal to a computing system that is paired with the audio system; and
receiving, from the computing system, a first correction derived in part from the first received signal.

3. The method of claim 1, wherein the audio device case includes a processor, and the method is further comprising:
transmitting the first received signal to the audio device case; and
receiving, from the audio device case, a first correction derived by the processor in part from the first received signal.

4. The method of claim 1, further comprising:
receiving, by the first audio device, an output signal;
applying the first correction to the output signal to produce a corrected signal; and
while the first audio device is not docked in the audio device case, emitting the corrected signal by the first speaker of the first audio device.

5. The method of claim 4, wherein the output signal is emitted into an acoustic cavity of a human ear, the output signal is part of an audiometry test of the human ear, and the method is further comprising:
in response to the emitting the output signal, collecting results of the audiometry test; and
transmitting data representing an audiogram based on the results from the audiometry test;

6. The method of claim 4, wherein the output signal is emitted into an acoustic cavity of a human ear, the output signal is a noise canceling signal, and further comprising:
sensing noise outside the acoustic cavity of the human ear; and
generating the noise canceling signal based on the sensed noise and the first correction.

7. The method of claim 4, wherein the output signal is emitted into an acoustic cavity of a human ear, and the method is further comprising:
applying a hearing compensation correction for the human ear to the output signal based on the first correction.

8. The method of claim 4, wherein the output signal is emitted into an acoustic cavity of a human ear, and further comprising:
analyzing the first received signals;
identifying a type of fault in first the audio system based on the analyzing; and
selecting the first correction based on the identified type of fault.

9. The method of claim 1, further comprising:
comparing the first received signal to a corresponding reference signal; and
wherein the first correction is determined based on the comparing to the corresponding reference signals;

10. The method of claim 1, wherein the corresponding reference signals were previously captured from sensors in an acoustic cavity of a test environment different from the acoustic cavity of the audio device case.

11. The method of claim 1, wherein the corresponding reference signals were previously captured from sensors in the acoustic cavity of the audio device case.

12. The method of claim 1, further comprising:
estimating a first transfer function between the first speaker of the first audio device and the first sensor of the audio system based on the first received signal; and
comparing the first transfer function to corresponding reference transfer function;
wherein the first correction is determined based on the comparing to reference transfer functions;

13. The method of claim 1, wherein the first sensor of the audio system is an accelerometer.

14. The method of claim 1, wherein the first sensor of the audio system is an audio sensor of the first audio device, and further comprising:
receiving, in response to the test audio signal, a second received signal at a second sensor of the first audio device;
receiving, in response to the test audio signal, a third received signal at a first sensor of a second audio device docked in the audio device case; and
receiving, in response to the test audio signal, a fourth received signal at a second sensor of the second audio device;
wherein the first correction is determined based on the first, second, third, and fourth received signals.

15. The method of claim 1, further comprising:
emitting a second test audio signal into the audio device case from a first speaker of a second audio device docked in the audio device case;
receiving, in response to the second test audio signal, a second received signal at the first sensor of the first audio device;
determining a second correction for the second audio device based on the second received signal.

16. The method of claim 1, further comprising:
prior to emitting the test audio signal, measuring an ambient noise; and
confirming a magnitude of the ambient noise is below a threshold.

17. The method of claim 1, further comprising:
evaluate a plurality of acoustic components of the audio system based on the first received signals; and
identifying an acoustic component of the plurality of acoustic components as having a failure state;
wherein the first correction includes a correction for the failure state of the identified acoustic component.

18. The method of claim 1, wherein the first sensor is part of the first audio device, and further comprising:
while the first audio device is not docked in the audio device case, receiving a first input signal at the first sensor;
applying the first correction to the first input signal to create a corrected input signal; and
transmitting the corrected input signal to a paired device.

19. An audio system comprising:
an audio device case including a base, a lid, a first cavity, and a second cavity;
a first audio device capable of docking in the first cavity of the audio device case and including a first speaker and a first sensor;
a second audio device capable of docking in the second cavity of the audio device case and including a first speaker and a first sensor; and
a processor configured to execute instructions that cause:
detecting that the first audio device is docked in the first cavity, the second device is docked in the second cavity; and the lid is in a closed position;
emitting a test audio signal from the first speaker into the audio device case;
receiving, in response to the test audio signal, a first received signal at a sensor inside the audio device case;
obtaining a first correction for the first audio device based on the first received signal.
